(19) United States
(12) Patent Application Publication
(10) Pub. No.: US 2021/0403214 A1
(43) Pub. Date: Dec. 30, 2021

(54) PRINTED RETORT PACKAGING MATERIALS AND RELATED METHODS

(71) Applicant: ePac Holdings, LLC, Austin, TX (US)

(72) Inventors: Sangameshwar Sangmule, La Crosse, WI (US); Jack Knott, Austin, TX (US)

(21) Appl. No.: 16/917,533

(22) Filed: Jun. 30, 2020

(51) Int. Cl. B65D 65/42; B65D 81/34; B32B 33/00; B32B 38/00; B32B 27/36; B32B 27/08

(52) U.S. Cl. CPC B65D 65/42; B65D 81/34; B32B 33/00; B32B 38/145; B32B 27/36; B32B 27/08; B32B 2439/70; B32B 2255/26; B32B 2255/10; B32B 2307/4023; B32B 2307/308; B32B 2307/406; B32B 2307/408; B65D 2581/34

(57) ABSTRACT

Methods of making printed flexible packaging material for retort applications include steps of digital printing on a flexible substrate material using polymeric ink and curing the printed ink. The printed ink on the material and packaging made therefrom exhibits resistance to blurring and discoloration under retort conditions.

### TECHNICAL FIELD

The present disclosure relates generally to printed flexible packaging materials and methods of making the same.

### BACKGROUND

Retort is a widely used process in which heat and pressure is used to cook food in a sealed package. Flexible retort pouches are popular as a cost-effective method to package pre-cooked foods for sale and consumption. In addition, they are favored for their amenability to various printing methods. Digital printing in particular is increasingly recognized as a valuable approach for packaging applications due to its speed and flexibility. Unlike traditional printing methods where each design to be printed requires creation of a printing plate, digital printing makes it easy to modify print designs as well as utilize multiple designs to produce multiple products.

During retorting, high temperature steam is used to sterilize and/or cook the contents. However, these hot, moist conditions can cause blurring and discoloration of inks printed on the flexible pouch material, thereby limiting potential for including high quality images and text on the packaging. This particularly impacts the ability to take advantage of the benefits of digital printing in retort packaging, as the electrophotographic inks typically used in digital printing presses soften or melt at or below retorting temperatures.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A shows a diagram of a cross-section view of a printed flexible packaging material 100a in accordance with an embodiment.

FIG. 1B shows a diagram of an exploded cross-section view of the printed flexible packaging material 100a shown in FIG. 1A.

FIG. 2A shows a diagram of a cross-section view of a reverse printed flexible packaging material 200a in accordance with another embodiment.

FIG. 2B shows a diagram of an exploded cross-section view of the reverse printed flexible packaging material 200a shown in FIG. 2A.

### DETAILED DESCRIPTION

The components of the embodiments as generally described and illustrated herein can be arranged and designed in a wide variety of different configurations. Thus, the following more detailed description of various embodiments is not intended to limit the scope of the present disclosure but is merely representative of various embodiments. It will be appreciated that various features are sometimes grouped together in a single embodiment, figure, or description thereof for the purpose of streamlining the disclosure. Many of these features may be used alone and/or in combination with one another.

The term “retort conditions” refers to various combinations of temperature, time and pressure typically used in a retort process to cook or otherwise process food or other materials in a sealed package. Retort conditions as contemplated herein include temperatures from 90° C. to 150° C.

The term “(meth)acrylate” encompasses acrylates and methacrylates as well as alkyl esters thereof, i.e., alkyl acrylates and alkyl methacrylates.

The term “(co)polymer” as applied herein to one or more monomers encompasses homopolymers of said monomers as well as copolymers, where “copolymer” refers to a polymer that is polymerized from at least two different monomers.

Flexible packaging, particularly pouches for containing food or other perishable products, is typically designed to provide certain properties conducive to that purpose, including but not limited to, food compatibility, i.e. suitability for sustained contact with food without affecting edibility or quality; an effective barrier to gas transfer between the interior and exterior of the package that would otherwise negatively affect food quality; resistance to puncture or rupture; and sealability by means such as heat. Additionally, retort pouches in particular are designed to maintain physical integrity under retort conditions. Accordingly, flexible packaging substrates of the embodiments described herein can comprise multiple layers of various kinds of films selected to provide these properties.

In various embodiments, flexible packaging substrates can include various polymers such as polyethylenes, including linear low density polyethylene (LLDPE), low density polyethylene (LDPE), medium density polyethylene (MDPE), high density polyethylene (HDPE), metallocene polyethylene, and ethyl vinyl acetate (EVA); polypropylenes, including cast polypropylene (CPP) and biaxially oriented polypropylene (BOPP); other polymers such as polyamide (e.g., oriented polyamide, nylon, etc.), polyethylene terephthalate (PET), ethylene vinyl acetate polymers, and co-polymers such as styrene-polybutadiene. Other layer materials include metal foils made from any of aluminum, silver, tin, copper, and mixtures thereof.

In various embodiments, a flexible packaging substrate can comprise a sealant layer that provides a food contact surface, where the layer and particularly the surface comprise materials suitable for direct food contact. Accordingly, this layer is typically disposed in the substrate so as to be the innermost surface of the package. As such, the layer providing the food contact surface can also be selected to be sealable. In some embodiments the sealant layer comprises a film of low-melting, i.e. heat sealable, thermoplastic material. Such materials include polypropylenes, particularly CPP and BOPP, as well as polyethylenes such as LLDPE (linear low-density polyethylene). In some embodiments, the sealant layer providing the food contact surface comprises CPP.

In various embodiments, a flexible packaging substrate can also comprise a printable polymer layer having a printable surface, i.e. a surface upon which ink can be printed to form an image such as text, coloration, and other visual design components. In various embodiments, the printable surface comprises material(s) suitable for printing using digital printing methods, such as electrophotographic or electrostatic printing. Such materials include polypropylene, BOPP, PET, polyamide, and polyvinyl chloride.

The present disclosure encompasses methods of making a printed packaging substrate, particularly a printed packaging substrate for retortable flexible packaging, and more particularly in which the packaging can be subjected to retort conditions with little to no loss of quality of the print on the package. In some embodiments, a method of making a printed flexible packaging material comprises steps of digitally printing a polymeric ink onto a printable surface of a flexible packaging substrate, and further curing the polymeric ink to produce crosslinking in the ink. The method further comprises laminating a cover film onto the polymeric ink and the printable surface with a solventless adhesive.

In other embodiments, a method comprises printing a polymeric ink onto a printable surface of a printable polymer layer, curing the polymeric ink to produce crosslinking in the ink, followed by laminating the now printed polymer layer to a prelaminate comprising the sealant layer. In a particular aspect of this method, the polymeric ink is reverse printed onto the printable surface of the printable polymer layer, where said printable surface is the underside of the printable polymer layer. After the laminating step, the printed ink is situated between the printable polymer layer and a layer of the prelaminate.

Printing the polymeric ink on the substrate can comprise printing an electrostatic polymeric ink composition onto the printable surface in an electrophotographic or electrostatic printing process. In various embodiments, the polymeric ink can be printed in a series of sequential printing steps to form a plurality of ink layers.

In certain embodiments, the method includes treating the printable surface to facilitate application of the ink by, e.g. increasing the surface tension of the surface to improve the wettability of the surface and promote adhesion of the ink to the surface. In certain embodiments, treating the printable surface comprises subjecting the surface to a corona treatment before printing. The parameters of the corona treatment, such as power, can be selected to achieve the desired surface tension based on the respective characteristics of the ink and the printable surface. In a particular embodiment, the corona treatment power is from about 400 W to about 2500 W, or more particularly from about 1500 W to about 2500 W, or still more particularly, about 2000 W.

In accordance with these embodiments, once the ink has been printed on the printable surface, curing radiation is applied to initiate crosslinking within the ink and optionally between the ink and the printable surface. In certain embodiments, curing is performed using electron beam irradiation. Those of skill in the art with the benefit of this disclosure will appreciate the certain details of electron beam irradiation as a general approach for curing polymeric compositions. The present disclosure encompasses the particular use of electron beam irradiation as part of a method of making printed flexible packaging substrates in which the printed ink resists rewetting under the high heat, pressure and moisture presented by retort conditions. In an aspect, the parameters of the electron beam irradiation, particularly the dose of radiation absorbed by the printed ink, can be selected to produce crosslinked printed ink that exhibits such resistance as a result of the curing step together with other steps of the method. In some embodiments, curing comprises providing electron beam irradiation in a dose of from about 50 kiloGreys (kGy) to about 150 kGy. In more particular embodiments, the dose is from about 100 kGy to about 120 kGy, or more particularly from 105 kGy to 115 kGy.

The polymeric inks for use in the embodiments described herein generally comprise a carrier liquid, a polymer resin and a colorant. In accordance with the curing step, the polymeric ink is one that is curable by irradiation, or more particularly it comprises polymeric components that form crosslinks in response to irradiation. In various embodiments, the polymeric ink comprises (co)polymers of one or more of (meth)acrylic acid, alkyl (meth)acrylates, ethylene, and vinyl acetate. In a particular embodiment, the polymeric ink comprises a (co)polymer of ethyl methacrylate.

Current approaches to digitally printing polymeric inks on flexible packaging materials typically involve the use of primers, particularly water-based primers, to promote better adhesion of the printed ink. For example, a surface to be printed upon may be flood coated with a water-based primer, onto which the ink is subsequently printed. However, water-based primers have the potential to rewet in moist/wet conditions such as retort conditions, which can lead to poor ink adhesion or ink pick off. An aspect of the embodiments described in the present disclosure is that the curing step can increase the degree of crosslinking between the printed ink and an underlying primer, thereby improving adhesion of the ink.

In some embodiments, the method further comprises laminating a cover film onto the polymeric ink and the printable surface. Without wishing to be bound by theory, the cover film may further contribute to resistance of the printed ink to blur and fading arising from retort conditions, providing protection from physical damage from storage and handling, as well as enhancing the visual appearance of the printed ink. In an aspect, the cover film can have various characteristics, such as composition and thickness, selected to provide at least one of these benefits. For example, the composition and thickness of the cover film can be selected so as to confer sufficient translucency or transparency to facilitate viewing of the underlying print. In certain embodiments, the cover film comprises a (co)polymer selected from polyethylene, polyester, polypropylene, or polystyrene. In certain embodiments, the cover film comprises PET. In certain embodiments, a cover film having a thickness of from about 0.3 mil to about 1.0 mil is laminated onto the polymeric ink and the printable surface.

The lamination steps of the methods of the present disclosure comprise using an adhesive to secure two film surfaces together to form a multilayer printed packaging substrate. In some embodiments, the adhesive is used to secure a cover film to the ink printed surface. In embodiments comprising reverse printing of the polymeric ink, the laminating step comprises securing the printable surface to a prelaminate. In various embodiments, this lamination step is done using a solventless adhesive. Solventless adhesives as contemplated by the present disclosure include adhesives in which the chemicals that provide bonding are not carried in a solvent, whether water or a volatile substance, that must evaporate or be driven off to achieve bonding. A typical representative of a solventless adhesive comprises two (or more) components that react together in situ to form a cross-linked adhesive polymer. Examples of this kind of adhesive include a hydroxylated polyester or polyether which is reacted with a di- or polyisocyanate, and an epoxy resin which is reacted with compounds containing at least two active hydrogen atoms. It is to be understood that any solventless adhesive as defined above may be used in accordance with the embodiments described herein.

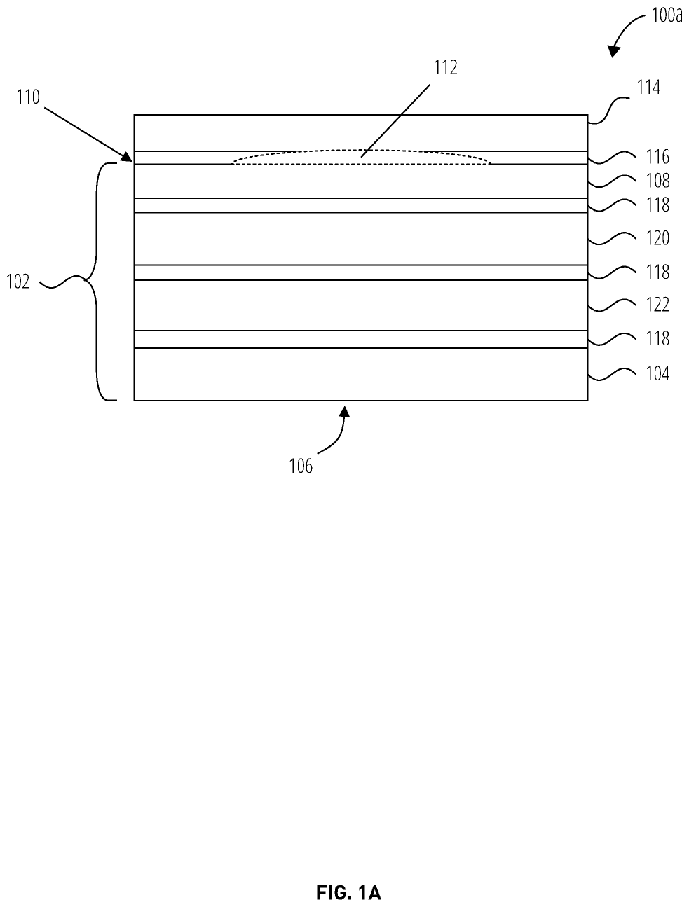

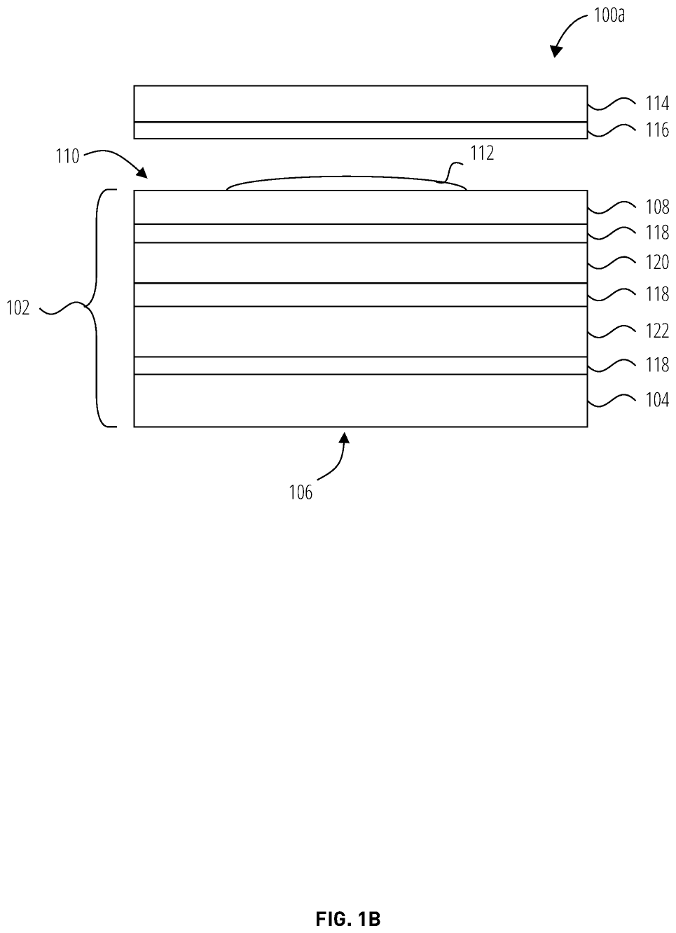

The present disclosure also encompasses printed flexible packaging materials and packaging articles comprising said materials for use in retort applications. In particular, these printed materials and articles are suited for retort applications in at least that they can be subjected to retort conditions without exhibiting a loss of print quality, such as fading or other discoloration, blurring, or ink pickoff. Accordingly, in some embodiments, as shown in cross-section in FIG. 1 and FIG. 1B, of which FIG. 1B shows an exploded view, a printed flexible packaging material 100 comprises a flexible packaging substrate 102 comprising a sealant layer 104 providing a food contact surface 106 and a printable polymer layer 108 providing a printable surface 110. A polymeric ink is digitally printed on the printable surface 110 and then cured according to the methods described above to produce a crosslinked polymeric ink 112. In some embodiments, the crosslinked polymeric ink 112 comprises a (co)polymer of one or more of (meth)acrylic acid, alkyl (meth)acrylates, ethylene, and vinyl acetate. In a particular embodiment, the crosslinked polymeric ink 112 comprises a (co)polymer of ethyl methacrylate. The crosslinked polymeric ink 112 exhibits crosslinking among at least a portion of the monomers that make up the constituent polymers of the ink. In a particular aspect, crosslinking may also exist between monomers in the ink and monomers in the printable surface 110. In some embodiments, the crosslinked polymeric ink 112 includes two or more layers of polymeric ink. In such embodiments, crosslinking may exist between adjacent layers of ink.

As also shown in FIGS. 1A and 1B, the printed flexible packaging material 100 further comprises a cover film 114 laminated onto the printable surface 110—and the crosslinked polymeric ink 112 printed thereon—with a solventless adhesive 116. In other embodiments, solvent adhesives are used. Properties of solventless adhesives that can be used in accordance with the embodiments are described above, and the solventless adhesive 116 may be any of these. As discussed above, the composition and thickness of the cover film can be selected so as to confer sufficient translucency or transparency to facilitate viewing of the underlying print. In certain embodiments, the cover film comprises a (co)polymer selected from polyethylenes, polyesters, polypropylenes, or polystyrenes. In some embodiments, the cover film is of essentially the same composition as the printable polymer layer 108. In particular embodiments, the cover film 114 comprises PET. In certain embodiments, the cover film has a thickness of from about 0.3 mil to about 1.0 mil. In some embodiments, the cover film is formulated to be substantially transparent so as to provide a gloss finish. In other embodiments, the cover film is formulated to provide a matte finish.

In various embodiments, the flexible packaging substrate 102 is a multilayer laminate structure comprising an array of layers that confer a combination of properties on the packaging which makes the packaging suitable for containment applications of interest. As shown by way of example in FIGS. 1A and 1B, in some embodiments the flexible packaging substrate 102 comprises the sealant layer 104 and printable polymer layer 108 as well as additional layers situated therebetween. In various embodiments, as exemplified by the FIGS. 1A and 1B, the layers of the flexible packaging substrate 102 are laminated using a solvent adhesive 118. In other embodiments, solventless adhesives are used. In some embodiments, the sealant layer 104 comprises a film of low-melting, i.e. heat sealable, thermoplastic material. Such materials include polypropylenes, particularly CPP and BOPP. In some embodiments, the sealant layer 104 providing the food contact surface comprises CPP. In some embodiments, the printable polymer layer 108 comprises a material suitable for being printed upon using digital printing methods. In various embodiments, the printable polymer layer 108 comprises one or more of polypropylene, PET, polyamide, and polyvinyl chloride. In particular embodiments, the printable polymer layer 108 comprises PET.

In some embodiments the flexible packaging substrate 102 further includes one or more of each of a polyamide (e.g., nylon) layer 120 and a foil layer 122 situated between the sealant layer 104 and the printable polymer layer 108. The relative positions of these layers in the laminate structure of the substrate as shown in FIGS. 1A and 1B are exemplary of a particular embodiment. However, it will be understood that other embodiments can include a different arrangement of these layers as well as different combinations of layers of materials encompassed by the present disclosure.

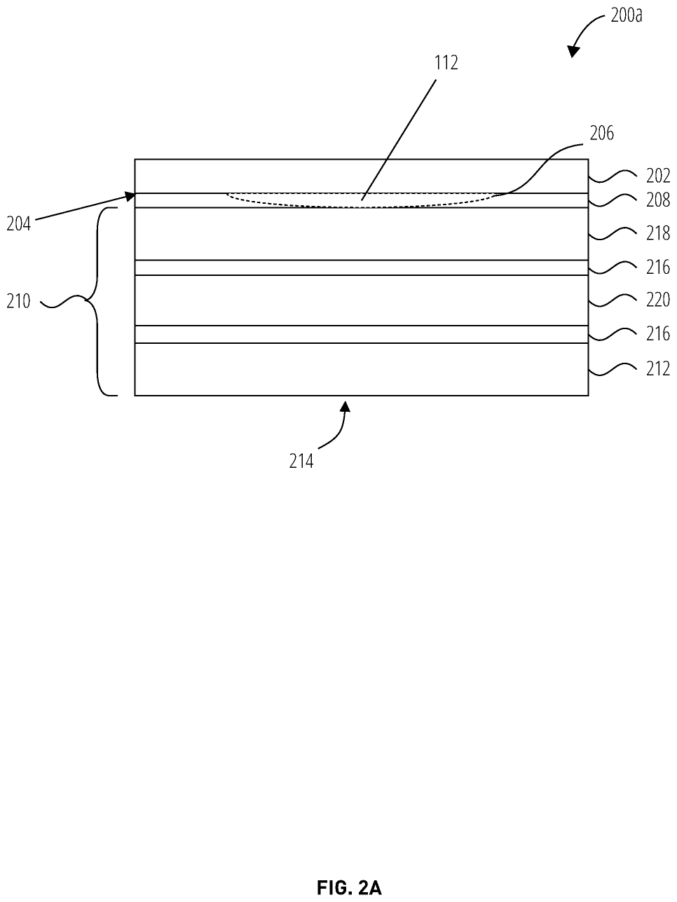

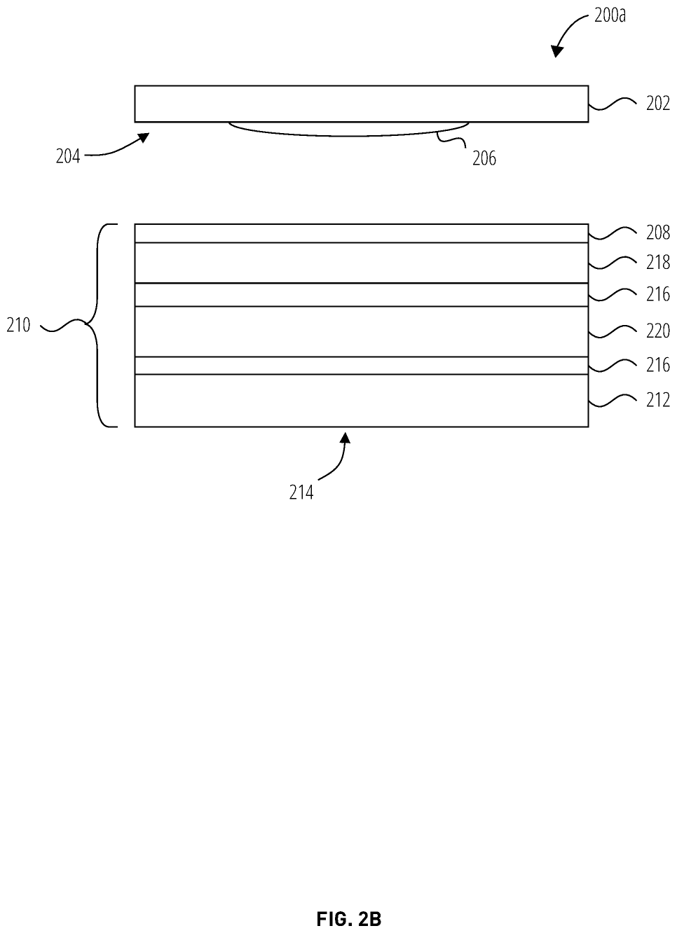

As shown in cross-section in FIG. 2A. and in exploded view in FIG. 2B, in some embodiments, a reverse printed flexible packaging material 200a comprises a printable polymer layer 202 providing a printable surface 204. A polymeric ink is digitally reverse printed on the printable surface 204 and then cured according to the methods described above to produce a crosslinked polymeric ink 206 as also described above. In various embodiments, the printable polymer layer 202 is composed so as to provide visibility and visual effect to the reverse printed ink. For example, in certain embodiments, the printable polymer layer can be substantially transparent, and more particularly can have a matte or gloss finish. The printable polymer layer 202 with the crosslinked polymeric ink 206 can be laminated using a solventless adhesive 208 to a prelaminate 210 comprising a sealant layer 212 providing a food contact surface 214. In some embodiments, the prelaminate 210 further comprises one or more additional layers laminated to the sealant layer 212 with a solvent adhesive 216, such as a foil layer 218 and a nylon layer 220 as shown by example in FIGS. 2A and 2B.

The printed flexible packaging material of the embodiments can be incorporated into printed flexible packaging articles for use in various containment applications, particularly for applications for which retortable packaging is indicated. In particular, the present disclosure encompasses a retort pouch comprising a printed flexible packaging material in accordance with any of the embodiments described herein. Relatedly, embodiments of the methods of making printed flexible packaging material described herein comprise a further step of forming a retort pouch from the printed flexible packaging material.

As discussed above, an aspect of the printed flexible package materials and articles encompassed by the present disclosure is that they are suited for retort applications in at least that they can be subjected to retort conditions without exhibiting a loss of print quality, such as fading or other discoloration, blurring, or ink pick. In various embodiments, the polymeric ink printed on these materials exhibits this resistance under retort conditions of temperature and duration that are typical for various containment applications. In some embodiments, the print is resistant under retort conditions comprising a temperature of from about 90° C. to about 150° C. for a duration from about 15 minutes to about 35 minutes without discoloration or blurring.

### EXAMPLES

To further illustrate these embodiments, the following examples are provided. These examples are not intended to limit the scope of the claimed invention, which should be determined solely on the basis of the attached claims.

Example 1: A retort pouch was constructed of a flexible packaging material made by the following process:
1. A multilayer prelaminated structure was provided having the arrangement (from printable surface to food contact surface): PET/SA/Aluminum Foil/SA/Nylon/SA/CPP;
2. The surface of the PET layer was digitally printed with polymeric inks comprising ethyl methacrylate resin;
3. The printed polymeric inks were electron beam cured using an eBeam Core 100 system (eBeam Technologies, Inc.) with the following settings:
   Dose: 100 kGy
   Voltage: 100 kV
   Corona treatment power: 2 kW
   Speed: 5 units
4. A 0.48 mil matte PET layer was laminated to the printed surface using a solventless adhesive to yield the final structure: Matte PET/SLA/EB cured Polymeric ink/PET/SA/Aluminum Foil/SA/Nylon/SA/CPP.

Abbreviations: CPP—cast polypropylene; EB—electron beam; PET—polyethylene terephthalate; SA—solvent adhesive; SLA—solventless adhesive.

The retort pouch was retorted at 125° C. for 30 minutes. The printed polymeric ink did not rewet or fade.

References to approximations are made throughout this specification, such as by use of the term “about.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. All ranges include both endpoints.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A printed flexible packaging material for retort applications, comprising:
a flexible packaging substrate comprising a sealant layer having a food contact surface and a printable polymer layer having a printable surface; and
a crosslinked polymeric ink digitally printed on the printable surface,
wherein the crosslinked polymeric ink is water resistant under retort conditions comprising a temperature of from about 90° C. to about 150° C. for a duration from about 15 minutes to about 35 minutes without discoloration or blurring.

2. The printed flexible packaging material of claim 1, wherein the crosslinked polymeric ink comprises a (co)polymer of one or more of (meth)acrylic acid, alkyl (meth)acrylates, ethylene, and vinyl acetate.

3. The printed flexible packaging material of claim 2, wherein the crosslinked polymeric ink comprises a (co)polymer of ethyl methacrylate.

4. The printed flexible packaging material of claim 1, wherein the printable surface comprises a polymer selected from polyethylene, polyester, polypropylene, and polystyrene.

5. The printed flexible packaging material of claim 4, wherein the printable surface comprises polyethylene terephthalate (PET).

6. The printed flexible packaging material of claim 1, wherein the printable surface faces away from the sealant layer, and further comprising a cover film laminated onto the polymeric ink and the printable surface with a solventless adhesive.

7. The printed flexible packaging material of claim 6, wherein the cover film comprises a polymer selected from polyethylene, polyester, polypropylene, and polystyrene.

8. The printed flexible packaging material of claim 7, wherein the cover film comprises polyethylene terephthalate (PET) having a matte or gloss finish.

9. The printed flexible packaging material of claim 1, wherein the flexible packaging substrate comprises one or more additional layers situated between the food contact surface and the printable surface, where each additional layer is one of a polyamide layer or a foil layer.

10. A method of making printed flexible packaging, comprising:
providing a flexible packaging substrate having a food contact surface and a printable surface;
digitally printing a polymeric ink onto the printable surface; and
curing the polymeric ink using electron beam irradiation;
laminating a cover film onto the polymeric ink and the printable surface with a solventless adhesive to produce a printed flexible packaging material.

11. The method of claim 10, wherein the electron beam irradiation is provided in a dose of from about 50 kGy to about 150 kGy.

12. The method of claim 11, wherein the dose is from about 100 kGy to about 120 kGy.

13. The method of claim 10, wherein the polymeric ink comprises a (co)polymer of one or more of (meth)acrylic acid, alkyl (meth)acrylates, ethylene, and vinyl acetate.

14. The method of claim 10, wherein the printable surface comprises a polymer selected from polyethylene, polyester, polypropylene, and polystyrene.

15. The method of claim 14, wherein the printable surface comprises polyethylene terephthalate (PET).

16. The method of claim 10, wherein the cover film comprises a polymer selected from polyethylene, polyester, polypropylene, and polystyrene.

17. The method of claim 16, wherein the cover film comprises polyethylene terephthalate (PET) having a matte or gloss finish.

18. The method of claim 10, further comprising subjecting the printable surface to a corona treatment before the step of digitally printing the polymeric ink onto the printable surface, wherein the corona treatment has a power from about 400 W to about 2500 W.

19. A method of making printed flexible packaging, comprising:
providing a printable polymer film having a printable surface;
digitally reverse printing a polymeric ink onto the printable surface;
curing the polymeric ink using electron beam irradiation; and
laminating the polymeric ink and the printable surface with a solventless adhesive to a prelaminate comprising a sealant layer to produce a printed flexible packaging material.

20. The method of claim 19, wherein the printable surface comprises polyethylene terephthalate (PET) having a matte or gloss finish.
